(19) United States
(12) Patent Application Publication
(10) Pub. No.: US 2026/0200300 A1
(43) Pub. Date: Jul. 16, 2026

(54) VEHICLE SUN VISOR DEVICE

(71) Applicant: John Winfrey, Sierra Madre, CA (US)

(72) Inventor: John Winfrey, Sierra Madre, CA (US)

(21) Appl. No.: 19/021,518

(22) Filed: Jan. 15, 2025

(51) Int. Cl. B60J 3/02

(52) U.S. Cl. CPC B60J 3/0208

(57) ABSTRACT

A vehicle sun visor device includes a first panel and a second panel. The first panel includes a connector that is designed to couple the first panel to a sun visor. A pivot hinge is connected to the first panel. The second panel is pivotably coupled to the first panel by the pivot hinge. The second panel is stacked with respect to the first panel in a stored position. The second panel is designed to be selectively pivoted away from the first panel in a first direction and into a first extended position. The second panel is designed to be selectively pivoted away from the first panel in a second direction different than the first direction and into a second extended position. A third panel is positioned within the first panel. The third panel includes tinted translucent material and is selectively slidable to project out of the first panel.

### (b) CROSS-REFERENCE TO RELATED APPLICATIONS

Not Applicable

### (c) STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### (f) STATEMENT REGARDING PRIOR DISCLOSURES BY THE INVENTOR OR JOINT INVENTOR

Not Applicable

### (g) BACKGROUND OF THE INVENTION

### (1) Field of the Invention

The disclosure relates to sun shades and visors for automobiles and more particularly pertains to a new vehicle sun visor device for providing additional areas of protection against sunlight and other light sources, such as headlights. Normal vehicle sun visors can be flipped down for straight ahead protection against sunlight in front of the driver, and alternatively can be flipped down and pivoted to the side for protection against sunlight from the side of the driver. However, this design is cumbersome and does not allow for simultaneous protection from both the front and the side. The new vehicle sun visor provides simultaneous protection from both the front and the side, as well as includes additional tinted extensions for protection without compromising visibility.

### (2) Description of Related Art Including Information Disclosed Under 37 CFR 1.97 and 1.98

The prior art relates to sun shades and visors for automobiles. The prior art, as best understood, does not disclose a vehicle sun visor that includes a first panel that connects onto an existing sun visor and a second panel pivotably coupled to the first panel, which second panel can pivot in two different directions to provide simultaneous protection from both the front and the side.

### (h) BRIEF SUMMARY OF THE INVENTION

An embodiment of the disclosure meets the needs presented above in a vehicle sun visor device generally comprising a first panel and a second panel. The first panel includes a connector that is designed to couple the first panel to a sun visor. A pivot hinge is connected to the first panel. The second panel is pivotably coupled to the first panel by the pivot hinge. The second panel is stacked with respect to the first panel in a stored position. The second panel is designed to be selectively pivoted away from the first panel in a first direction and into a first extended position. The second panel is designed to be selectively pivoted away from the first panel in a second direction different than the first direction and into a second extended position. A third panel is positioned within the first panel. The third panel includes tinted translucent material. The third panel is selectively slidable to project out of the first panel.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a vehicle sun visor device according to an embodiment of the disclosure.

FIG. 2 is a front view of an embodiment of the disclosure in use.

FIG. 3 is a side view of an embodiment of the disclosure in use.

FIG. 4 is a back view of an embodiment of the disclosure.

FIG. 5 is a bottom view of an embodiment of the disclosure.

FIG. 6 is a front open view of an embodiment of the disclosure.

FIG. 7 is a front open extended view of an embodiment of the disclosure.

FIG. 8 is an alternative front open view of an embodiment of the disclosure.

FIG. 9 is perspective view of an embodiment of the disclosure.

### (j) DETAILED DESCRIPTION OF THE INVENTION

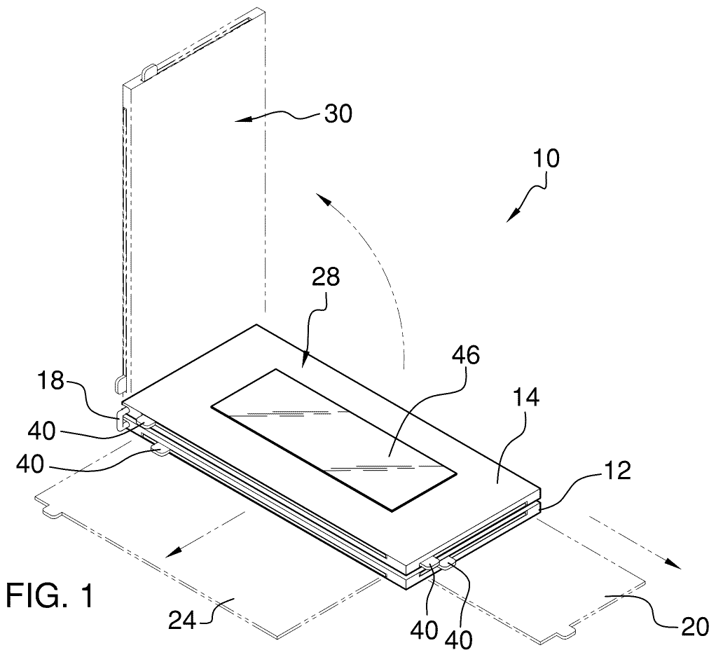

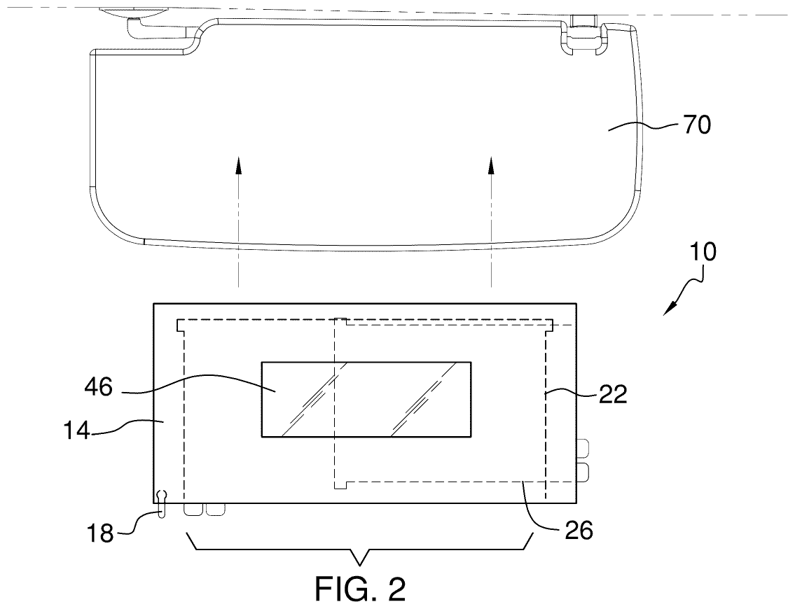

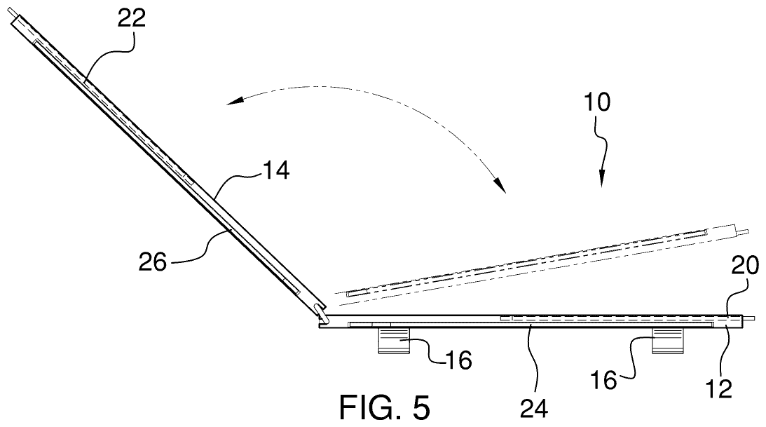

With reference now to the drawings, and in particular to FIGS. 1 through 9 thereof, a new vehicle sun visor device embodying the principles and concepts of an embodiment of the disclosure and generally designated by the reference numeral 10 will be described.

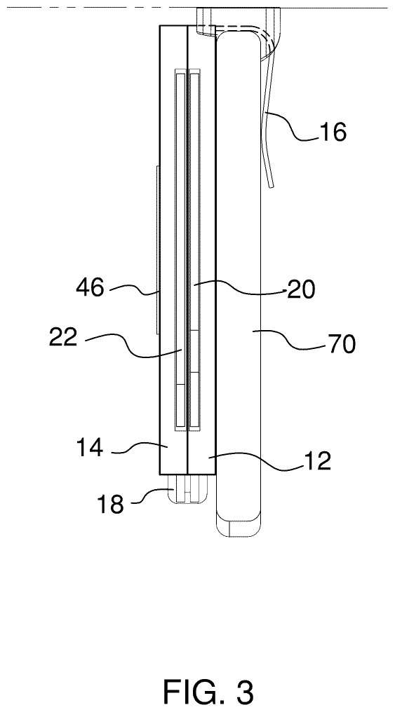

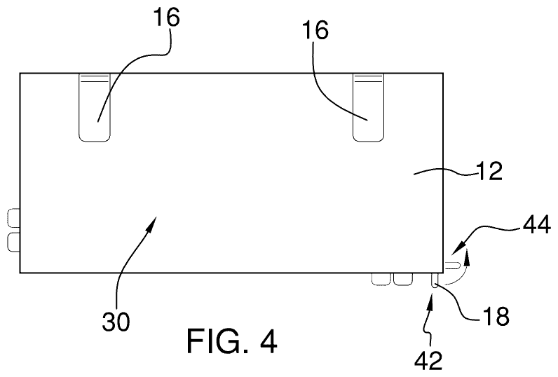

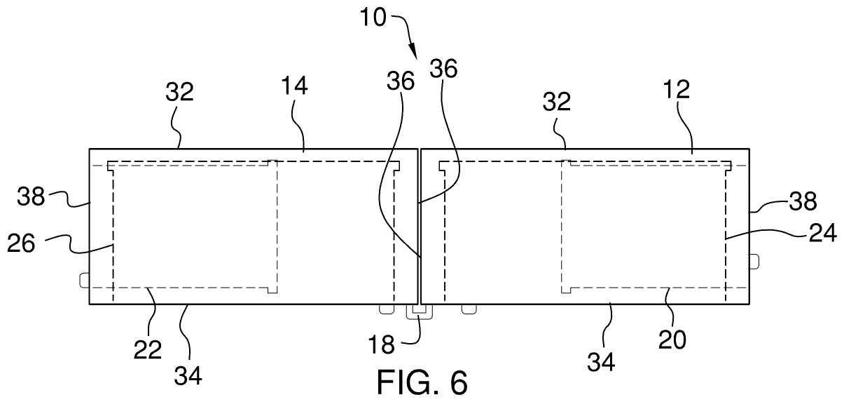

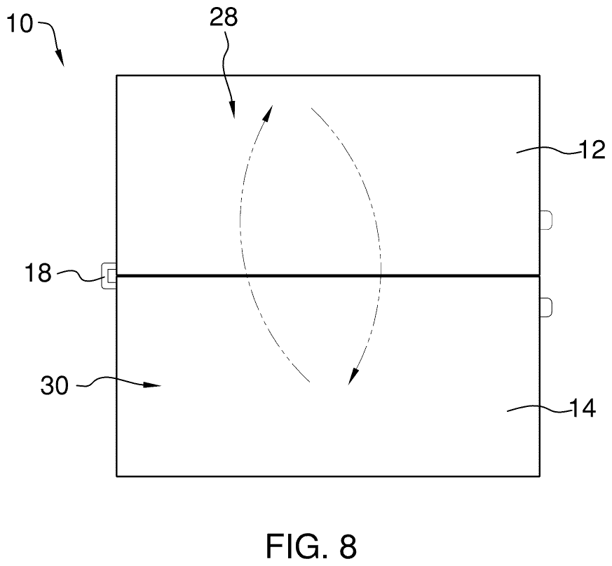

As best illustrated in FIGS. 1 through 9, the vehicle sun visor device 10 generally comprises A vehicle sun visor device 10 includes a first panel 12 and a second panel 14. The first panel 12 includes a connector 16 that is designed to couple the first panel 12 to an existing sun visor 70 of an automobile. As shown in FIGS. 3 and 4, the connector 16 is a pair of clips that can be slid over the existing sun visor 70, though other detachable connections could be used, such as elastic or plastic straps or bands. A pivot hinge 18 is connected to the first panel 12. The second panel 14 is pivotably coupled to the first panel 12 by the pivot hinge 18. The second panel 14 is stacked with respect to the first panel 12 in a stored position. As best seen in FIGS. 6 and 8, the second panel 14 is designed to be selectively pivoted away from the first panel 12 in a first direction and into a first extended position, but is also designed to be selectively pivoted away from the first panel 12 in a second direction different than the first direction and into a second extended position. FIG. 6 shows what would be a left pivot when the vehicle sun visor device 10 is installed on the existing sun visor 70 for the driver's side of the vehicle, and FIG. 8 shows what would be a downward pivot. While this design is for the driver's side, the vehicle sun visor device 10 could have a reverse design suitable for a passenger's side of the vehicle. A third panel 20 is positioned within the first panel 12. The third panel 20 includes tinted translucent material. The third panel 20 is selectively slidable to project out of the first panel 12.

As shown in the figures, the vehicle sun visor device 10 includes multiple tinted extensions. While four are shown in the exemplary embodiment, more or fewer could be included in at least one possible embodiment. In the exemplary embodiment, in addition to the third panel 20, the vehicle sun visor device 10 further includes a fourth panel 22, a fifth panel 24, and a sixth panel 26, each of which includes tinted translucent material like the third panel 20. These can be designed to have the same or different levels of translucence. They can be made to block more or less of sunlight. The translucent design provides additional sun protection without compromising visibility. Like the third panel 20, each of the fourth panel 22, the fifth panel 24, and the sixth panel 26 is selectively slidable to project out of its respective first panel 12 or second panel 14. Specifically, the fourth panel 22 is positioned within the second panel 14, the fifth panel 24 is positioned within the first panel 12, and the sixth panel 26 is positioned within the second panel 14.

Each of the first panel 12 and the second panel 14 includes a front surface 28 and a rear surface 30. In the exemplary embodiment, the first panel 12 and the second panel 14 are rectangular, though other shapes, such as square or trapezoidal are within the scope of the disclosure. Each of the first panel 12 and the second panel 14 includes a top edge 32, a bottom edge 34, a first side edge 36, and a second side edge 38. As shown in FIGS. 1 and 3, the front surface 28 of the first panel 12 is oriented to face the rear surface 30 of the second panel 14, and each of the top edge 32, the bottom edge 34, the first side edge 36, and the second side edge 38 of the first panel 12 is aligned respectively with each of the top edge 32, the bottom edge 34, the first side edge 36, and the second side edge 38 of the second panel 14, when the second panel 14 is stacked in the stored position.

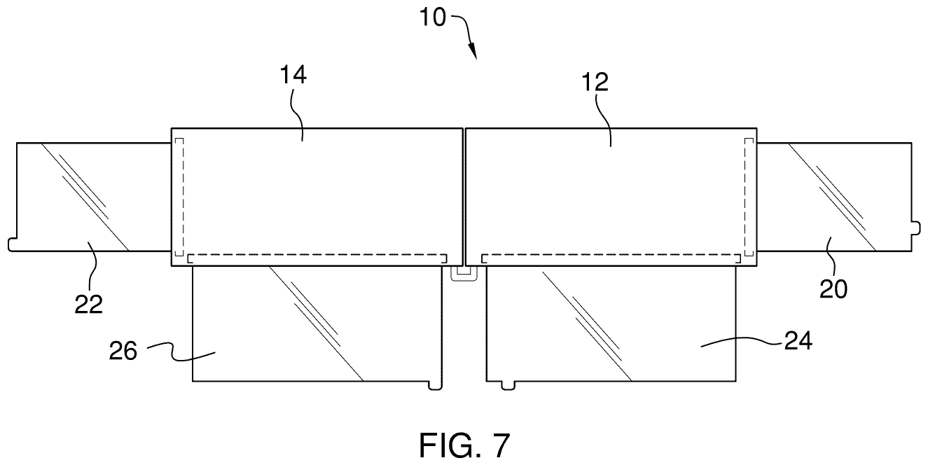

In the exemplary embodiment, best seen in FIG. 7, the third panel 20 is extendable from the second side edge 38 of the first panel 12. The fourth panel 22 is extendable from the second side edge 38 of the second panel 14. The fifth panel 24 is extendable from the bottom edge 34 of the first panel 12. The sixth panel 26 is extendable from the bottom edge 34 of the second panel 14. The user therefore has multiple possible configurations to address various directions of sunlight. Each of these panels can include a pull tab 40 for manual movement.

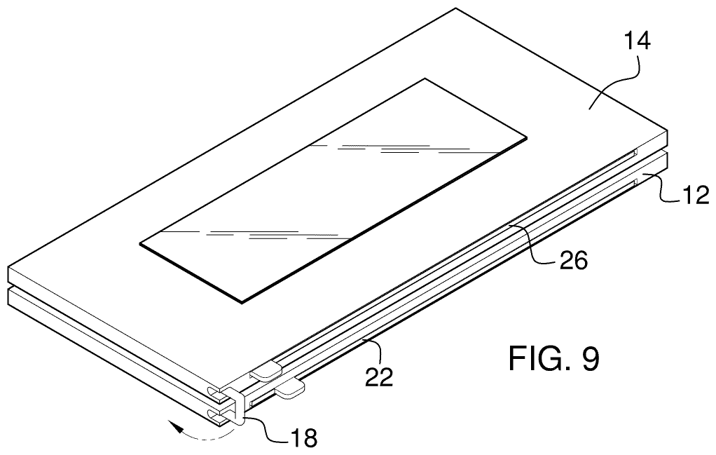

As mentioned above, the second panel 14 is pivotable in two different directions, which pivoting is accomplished with the pivot hinge 18. A possible design of the pivot hinge 18 is shown in the figures, though other designs are possible to accomplish the same function, as is well known in the mechanical arts. In the exemplary embodiment in FIG. 9, the pivot hinge 18 is adjustably connected to the first panel 12 at a corner formed by the bottom edge 34 and the first side edge 36 of the first panel 12, and adjustably connected to the second panel 14 at a corner formed by the bottom edge 34 and the first side edge 36 of the second panel 14. As shown in FIGS. 4 and 9, the pivot hinge 18 is selectively movable between a first position 42 in which the second panel 14 is pivotable about the bottom edge 34 of the first panel 12 and a second position 44 in which the second panel 14 is pivotable about the first side edge 36 of the first panel 12. The user therefore can alter the pivoting movement of the second panel 14 by moving the pivot hinge 18 from the first position 42 to the second position 44 and vice versa.

In the exemplary embodiment, each of the first panel 12 and the second panel 14 is made of opaque material, though in another possible embodiment they could be made of translucent material. Any of the panels disclosed herein could be made of a combination of translucent and opaque materials. In the exemplary embodiment, a mirror 46 is included on the front surface 28 of the second panel 14.

To use the vehicle sun visor device 10, the user simply clips the vehicle sun visor device 10 onto the existing sun visor 70 of a vehicle. The user can then pivot the second panel 14 as desired, either downwardly for additional straight ahead protection or to the left for side protection in addition to the straight ahead protection provided by the first panel 12. The user can also extend any one or more of the third panel 20, the fourth panel 22, the fifth panel 24, and the sixth panel 26 as desired for additional protection against sunlight or other lights.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A vehicle sun visor device comprising:
a first panel, said first panel including a connector being configured to couple said first panel to a sun visor;
a pivot hinge being connected to said first panel;
a second panel, said second panel being pivotably coupled to said first panel by said pivot hinge, said second panel being stacked with respect to said first panel in a stored position, said second panel being configured to be selectively pivoted away from said first panel in a first direction and into a first extended position, said second panel being configured to be selectively pivoted away from said first panel in a second direction different than said first direction and into a second extended position; and
a third panel being positioned within said first panel, said third panel including tinted translucent material, said third panel being selectively slidable to project out of said first panel.

2. The vehicle sun visor device of claim 1, further including a fourth panel being positioned within said second panel, said fourth panel including tinted translucent material, said fourth panel being selectively slidable to project out of said second panel.

3. The vehicle sun visor device of claim 2, further including a fifth panel being positioned within said first panel, said fifth panel including tinted translucent material, said fifth panel being selectively slidable to project out of said first panel.

4. The vehicle sun visor device of claim 3, further including a sixth panel being positioned within said second panel, said sixth panel including tinted translucent material, said sixth panel being selectively slidable to project out of said second panel.

5. The vehicle sun visor device of claim 4, wherein:
each of said first panel and said second panel includes a front surface and a rear surface;
each of said first panel and said second panel includes a top edge, a bottom edge, a first side edge, and a second side edge; and
said front surface of said first panel is oriented to face said rear surface of said second panel, and each of said top edge, said bottom edge, said first side edge, and said second side edge of said first panel is aligned respectively with each of said top edge, said bottom edge, said first side edge, and said second side edge of said second panel, when said second panel is stacked in said stored position.

6. The vehicle sun visor device of claim 5, wherein said pivot hinge is adjustably connected to said first panel at a corner formed by said bottom edge and said first side edge of said first panel, and adjustably connected to said second panel at a corner formed by said bottom edge and said first side edge of said second panel.

7. The vehicle sun visor device of claim 6, wherein said pivot hinge is selectively movable between a first position in which said second panel is pivotable about said bottom edge of said first panel and a second position in which said second panel is pivotable about said first side edge of said first panel.

8. The vehicle sun visor device of claim 7, wherein:
said third panel is extendable from said second side edge of said first panel;
said fourth panel is extendable from said second side edge of said second panel;
said fifth panel is extendable from said bottom edge of said first panel; and
said sixth panel is extendable from said bottom edge of said second panel.

9. The vehicle sun visor device of claim 8, wherein each of said first panel and said second panel is made of opaque material.

10. The vehicle sun visor device of claim 1, wherein:
each of said first panel and said second panel includes a front surface and a rear surface;
each of said first panel and said second panel includes a top edge, a bottom edge, a first side edge, and a second side edge; and
said front surface of said first panel is oriented to face said rear surface of said second panel, and each of said top edge, said bottom edge, said first side edge, and said second side edge of said first panel is aligned respectively with each of said top edge, said bottom edge, said first side edge, and said second side edge of said second panel, when said second panel is stacked in said stored position.

11. The vehicle sun visor device of claim 10, wherein said pivot hinge is adjustably connected to said first panel at a corner formed by said bottom edge and said first side edge of said first panel, and adjustably connected to said second panel at a corner formed by said bottom edge and said first side edge of said second panel.

12. The vehicle sun visor device of claim 11, wherein said pivot hinge is selectively movable between a first position in which said second panel is pivotable about said bottom edge of said first panel and a second position in which said second panel is pivotable about said first side edge of said first panel.

13. The vehicle sun visor device of claim 5, wherein said third panel is extendable from said second side edge of said first panel.

14. The vehicle sun visor device of claim 5, wherein said fourth panel is extendable from said second side edge of said second panel.

15. The vehicle sun visor device of claim 5, wherein said fifth panel is extendable from said bottom edge of said first panel.

16. The vehicle sun visor device of claim 5, wherein said sixth panel is extendable from said bottom edge of said second panel.

17. The vehicle sun visor device of claim 5, wherein:
said third panel is extendable from said second side edge of said first panel;
said fourth panel is extendable from said second side edge of said second panel;
said fifth panel is extendable from said bottom edge of said first panel; and
said sixth panel is extendable from said bottom edge of said second panel.

18. The vehicle sun visor device of claim 1, wherein each of said first panel and said second panel is made of opaque material.
